(19) United States
(12) Patent Application Publication
(10) Pub. No.: US 2024/0212254 A1
(43) Pub. Date: Jun. 27, 2024

(54) INFORMATION PROCESSING APPARATUS, COMPUTER-READABLE RECORDING MEDIUM STORING PROGRAM, AND CONTROL METHOD

(71) Applicant: Fujitsu Limited, Kawasaki-shi (JP)

(72) Inventors: Hiroyoshi KODAMA, Isehara (JP); Takahide YOSHIKAWA, Kawasaki (JP)

(73) Assignee: Fujitsu Limited, Kawasaki-shi (JP)

(21) Appl. No.: 18/471,769

(22) Filed: Sep. 21, 2023

(30) Foreign Application Priority Data
Dec. 23, 2022 (JP) 2022-207309

(51) Int. Cl. G06T 15/00; G06F 13/10

(52) U.S. Cl. CPC G06T 15/005; G06F 13/10

(57) ABSTRACT

An information processing apparatus provided in a computer system including a first processor; an interconnect switch that conforms to an interconnect standard and a plurality of devices coupled to the processor via the interconnect switch includes a second processor, when a processing delay for a processing target is detected in a first device among the plurality of devices, configured to cause a second device among the plurality of devices that is different from the first device to process the processing target.

### CROSS-REFERENCE TO RELATED APPLICATION

This application is based upon and claims the benefit of priority of the prior Japanese Patent Application No. 2022-207309, filed on Dec. 23, 2022, the entire contents of which are incorporated herein by reference.

### FIELD

The embodiments discussed herein are related to an information processing apparatus, a computer-readable recording medium storing program, and a control method.

### BACKGROUND

In recent years, an increase in calculation performance of a central processing unit (CPU) is becoming smaller than that in the past due to approaching of limits of manufacturing processes of the CPU. For this reason, many efforts have been made to improve the performance at a system level.

US Patent Application Publication Nos. 2020/0242724 and 2018/0300238, and Japanese Laid-open Patent Publication No. 2021-190125 are disclosed as related art.

### SUMMARY

According to an aspect of the embodiments, an information processing apparatus provided in a computer system including a first processor; an interconnect switch that conforms to an interconnect standard and a plurality of devices coupled to the processor via the interconnect switch includes a second processor, when a processing delay for a processing target is detected in a first device among the plurality of devices, configured to cause a second device among the plurality of devices that is different from the first device to process the processing target.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a configuration of a computer system as an example of a first embodiment;

FIG. 2 is a diagram illustrating a hardware configuration of a CU in the computer system as an example of the first embodiment;

FIG. 3 is a diagram illustrating functional configurations of a CXL extension function unit, the CU, and an FPGA extension function unit in the computer system as an example of the first embodiment;

FIG. 4 is a diagram illustrating a method of enhancing parallel processing in the computer system as an example of the first embodiment;

FIG. 5 is a sequence diagram for explaining processing in the computer system as an example of the first embodiment;

FIG. 6 is a diagram illustrating states of the computer system before and after the processing illustrated in the sequence diagram of FIG. 5;

FIG. 7 is a diagram illustrating a configuration of a computer system as an example of a second embodiment;

FIG. 8 is a diagram illustrating functional configurations of the CXL extension function unit, the CU, and a GPU extension function unit in the computer system as an example of the second embodiment; and

FIG. 9 is a sequence diagram illustrating processing in the computer system as an example of the second embodiment.

### DESCRIPTION OF EMBODIMENTS

For example, hardware commonly referred to as accelerator such as a graphics processing unit (GPU) or a field-programmable gate array (FPGA) is used in addition to the CPU as one of techniques for improving performance of an application. A communication function of the CPU is also offloaded to a device called Smart network interface card (NIC).

In recent years, the accelerator such as the FPGA or the GPU is coupled to the CPU via an interconnect. Compute Express Link (CXL®) is known as an interconnect of such a system configuration. For example, a system for managing memory resources coupled by using a CXL switch is known.

However, in such an interface using the CXL switch in the related art, only the memories are managed, and managing of the FPGA or the GPU is thus not possible. Accordingly, the above interface has such a problem that a processing delay occurs when an application makes a request to perform data processing exceeding an assumed level, to the FPGA or the GPU.

According to one aspect, an object of the present disclosure is to reduce a processing delay.

Hereinafter, embodiments of an information processing apparatus, a program, and a control method are described with reference to the drawings. The embodiments described below are merely examples, and are not intended to exclude application of various modification examples and techniques that are not explicitly described in the embodiments. For example, the present embodiments may be carried out while being modified in various ways (such as combining the embodiments and each of the modification examples) within a scope not departing from the spirit of the present embodiments. Each of the drawings is not provided with an intention that only the constituent elements illustrated in the drawing are included, and other functions and the like may be included.

### (I) DESCRIPTION OF FIRST EMBODIMENT

### (A) Configuration

### [A-1] Hardware Configuration Example

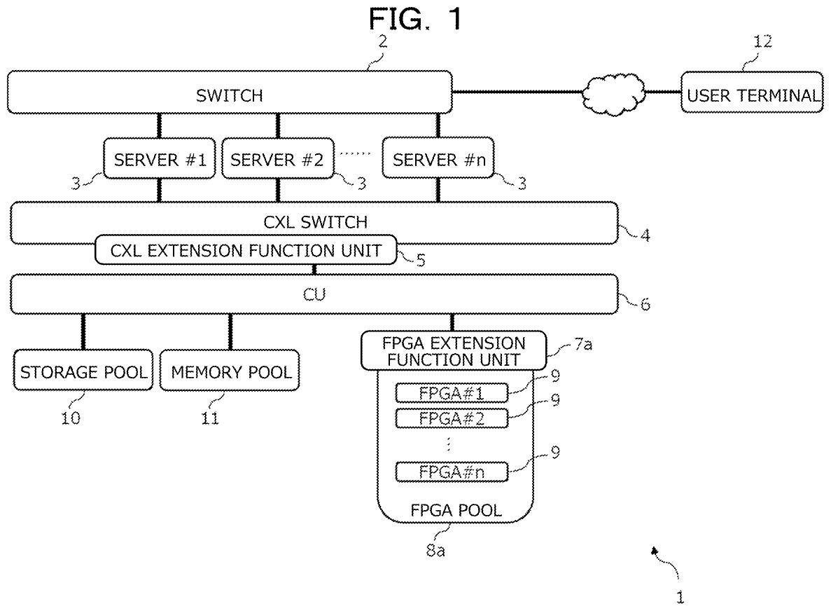

FIG. 1 is a diagram illustrating a configuration of a computer system 1 as an example of a first embodiment.

The computer system 1 illustrated in FIG. 1 includes a switch 2, a CXL switch 4, a CXL extension function unit 5, a CU 6, a storage pool 10, an FPGA extension function unit 7a, an FPGA pool 8a, a memory pool 11, a user terminal 12, and one or more (n servers in the example illustrated in FIG. 1) servers 3.

The user terminal 12 is a computer used by a user. For example, the user terminal 12 may be coupled to the switch 2 via Ethernet®. Multiple user terminals 12 may be provided. Multiple servers 3 are coupled to the switch 2.

The user terminal 12 inputs a job based on an operation or the like by a user. The job inputted from the user terminal 12 is transmitted to one of the multiple servers 3 via the switch 2.

The switch 2 controls communication between the user terminal 12 and the multiple servers 3. For example, the switch 2 forwards a job transmitted from the user terminal 12 to the corresponding server 3. The switch 2 forwards an execution result of the job returned from the server 3 to the user terminal 12. For example, the switch 2 may be a top of rack (ToR) switch or a Smart NIC. For example, the switch 2 and each of the servers 3 may be coupled to each other by Ethernet.

Multiple storage devices (devices) are registered in the storage pool 10. Storage areas of the storage devices in the storage pool 10 are provided in response to requests from the servers 3. Multiple memory devices (devices) are registered in the memory pool 11. Memory areas of the memory devices in the memory pool 11 are provided in response to requests from the servers 3.

Multiple FPGAs (devices) 9 are registered in the FPGA pool 8a. Jobs inputted from the user terminal 12 are transmitted to the FPGAs 9 in the FPGA pool 8a via the servers 3, the CXL switch 4, and the control unit (CU) 6. The FPGAs 9 process the received jobs, and return execution results (transmit a results) of the jobs to the servers 3 via the CU 6 and the CXL switch 4. The servers 3 transmit the returned execution results to the user terminal 12.

The multiple FPGAs 9 registered in the FPGA pool 8a may include an FPGA 9 in a hot standby (hot spare) state in which no job is processed.

The FPGA pool 8a includes the FPGA extension function unit 7a. The FPGA extension function unit 7a is interposed between the CU 6 and the FPGA pool 8a. The FPGA extension function unit 7a manages the FPGAs 9 in the FPGA pool 8a according to a special packet transmitted from the CU 6 (CXL switch 4). Details of the FPGA extension function unit 7a will be described later.

The servers 3 are computers having server functions. Each server 3 includes a not-illustrated processor, and the processor executes a program to implement various function. The processor of the server 3 may be a central processing unit (CPU). The processor of the server 3 corresponds to a first processor.

When the server 3 processes a job transmitted from the user terminal 12, the server 3 transmits a job processing request (performs job input) to the FPGAs 9 in the FPGA pool 8a as desired.

The job issued by the server 3 in this case may include multiple tasks. These tasks may be processed by multiple FPGAs 9. The multiple tasks may be sorted to multiple flows, and the multiple flows may be processed in parallel by the multiple FPGAs 9.

The server 3 requests a storage area or a memory area to the storage pool 10 or the memory pool 11.

The CXL switch 4 is an interconnect switch conforming to an interconnect standard. The CXL switch 4 is coupled to the multiple servers 3, and is also coupled to the storage pool 10, the memory pool 11, and the FPGA pool 8a via the CU 6. The CXL switch 4 controls communication between the multiple servers 3 and the storage devices included in the storage pool 10, the memories included in the memory pool 11, and the FPGAs 9 included in the FPGA pool 8a. The CXL switch 4 generates and processes packets according to each of protocols of CXL.io, CXL.cache, and CXL.mem.

The CXL extension function unit 5 is added to the CXL switch 4. The CXL extension function unit 5 extends a function of the CXL switch 4. Details of this CXL extension function unit 5 will be described later.

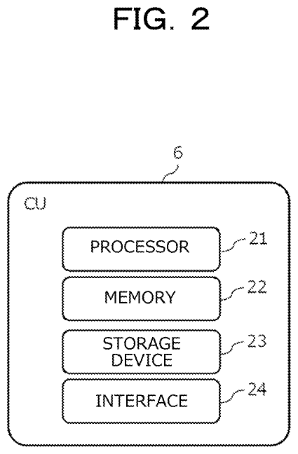

FIG. 2 is a diagram illustrating a hardware configuration of the CU 6 in the computer system 1 as an example of the first embodiment.

As illustrated in FIG. 2, the CU 6 may be an information processing apparatus including a processor 21, a memory 22, a storage device 23, and an interface 24. The computer system 1 corresponds to a computer system including the processors (first processors) of the servers 3, the CXL switch 4 (interconnect switch) conforming to the interconnect standard, and multiple devices coupled to the processors of the servers 3 via the CXL switch 4. The CU 6 corresponds to an information processing apparatus included in the computer system 1.

The processor 21 is an example of a computation processing device that performs various controls and computations, and is a control unit that executes various processes. The processor 21 may be coupled to each of blocks in the CU 6 via a not-illustrated bus to be communicable with the blocks. The processor 21 may be a multiprocessor including multiple processors, a multi-core processor including multiple processor cores, or a configuration including multiple multi-core processors.

Examples of the processor 21 include integrated circuits (ICs) such as a CPU, an MPU, an APU, a DSP, an ASIC, and an FPGA. A combination of two or more of these integrated circuits may be used as the processor 21. MPU is an abbreviation for microprocessor unit, and APU is an abbreviation for accelerated processing unit. DSP is an abbreviation for digital signal processor, and ASIC is an abbreviation for application specific IC. The processor 21 corresponds to a second processor.

The memory 22 is an example of hardware (HW) that stores information such as various pieces of data and programs. Examples of the memory 22 include one or both of a volatile memory such as a dynamic random-access memory (DRAM) and a non-volatile memory such as a persistent memory (PM).

The storage device 23 is an example of HW that stores information such as various pieces of data and programs. Examples of the storage unit 23 include a magnetic disk device such as a hard disk drive (HDD), a semiconductor drive device such as a solid-state drive (SSD), and various storage devices such as a non-volatile memory. Examples of the non-volatile memory include a flash memory, a storage class memory (SCM), a read-only memory (ROM), and the like.

A program (communication control program: not illustrated) that implements all or part of various functions of the CU 6 may be stored in the storage device 23.

For example, the processor 21 of the CU 6 may load the program stored in the storage device 23 into the memory 22, and execute the program to implement a control function to be described later.

The program may be read from a not-illustrated recording medium storing the program, and stored in the storage device 23.

Examples of the recording medium include non-transitory computer-readable recording media such as a magnetic/optical disc and a flash memory. Examples of the magnetic/optical disc include a flexible disk, a compact disc (CD), a Digital Versatile Disc (DVD), a Blu-ray disc, a holographic versatile disc (HVD), and the like. Examples of the flash memory include semiconductor memories such as a Universal Serial Bus (USB) memory and an SD card.

The interface 24 is an interface for coupling the CXL switch 4, the storage pool 10, the memory pool 11, and the FPGA pool 8a to the CU 6. For example, the interface 24 may be an interface based on a Peripheral Component Interconnect Express (PCIe) standard, and may include a PCIe connector.

The HW configuration of the CU 6 described above is an example. Accordingly, pieces of HW in the CU 6 may be increased, decreased (for example, arbitrary block may be added or deleted), divided, or integrated in arbitrary combination, the bus may be added, deleted, or the like and any other modification may be performed as appropriate.

### [A-2] Functional Configuration Example

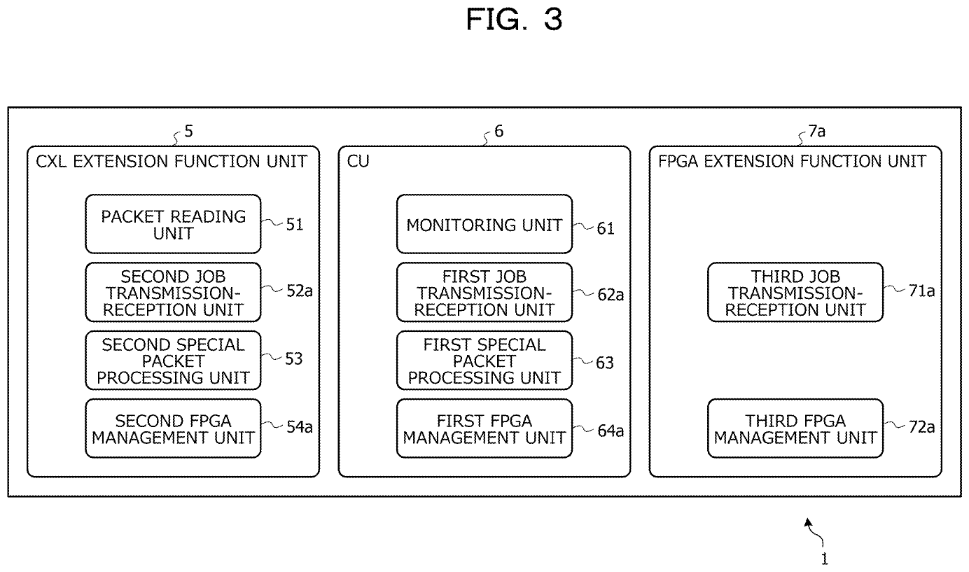

FIG. 3 is a diagram illustrating functional configurations of the CXL extension function unit 5, the CU 6, and the FPGA extension function unit 7a in the computer system 1 as an example of the first embodiment.

The CU 6 is a control device that controls multiple devices (multiple FPGAs 9 in the present first embodiment), and implements a function of autonomously controlling the FPGAs 9 in the FPGA pool 8a without communicating with the processors of the servers 3.

When the control unit (CU) 6 detects a processing delay for a processing delay task (processing target) in a processing delay FPGA 9 (first device) among the multiple FPGAs 9 (devices), the CU 6 causes an assistant FPGA 9 (second device) among the multiple FPGAs 9 that is different from the processing delay FPGA 9 to process the processing delay task that is the processing target.

The CU 6 achieves balancing of processing load as follows. The CU 6 monitors a load status of the FPGA 9 and, when detecting the processing delay in the FPGA 9, adds an FPGA 9 to cause the added FPGA 9 to assist the processing.

As illustrated in FIG. 3, the CU 6 has functions as a monitoring unit 61, a first job transmission-reception unit 62a, a first special packet processing unit 63, and a first FPGA management unit 64a.

The monitoring unit 61 monitors and analyzes an operation state of each of the FPGAs 9 in the FPGA pool 8a. The monitoring unit 61 may collect information indicating the operation state of each FPGA 9 from the each FPGA 9, as monitoring of the operation status of the each FPGA 9.

For example, the monitoring unit 61 may obtain an execution state of a job in each FPGA 9 as the information indicating the operation state of the each FPGA 9. The execution state of the job may include, for example, the number (count) of jobs to be processed by the FPGA 9, power consumption, execution time, and the like. The execution time of the job in the FPGA 9 may be time from input of the job into the FPGA 9 to output of a response. The operation status of the FPGA 9 may also be referred to as a load state of the FPGA 9.

The information indicating the operation state of each FPGA 9 is collected via the FPGA extension function unit 7a to be described later.

The monitoring unit 61 measures a change in the information indicating the operation status, as analysis of the operation status of each FPGA 9.

For example, the monitoring unit 61 compares the execution time of the job in the FPGA 9 with the previous execution time of the same job in the same FPGA 9. When the execution time of the job is longer than the previous execution time of the same job by predetermined time (threshold) or more as a result of the comparison, the monitoring unit 61 detects the processing delay in the FPGA 9. The FPGA 9 in which the processing delay is detected may be referred to as processing delay FPGA 9. The task executed by the processing delay FPGA 9 may be referred to as processing delay task.

When the monitoring unit 61 detects the processing delay in an FPGA 9, the operation mode of the computer system 1 transitions from a normal mode to a load distribution mode. For example, the monitoring unit 61 may store information indicating the operation mode of the present computer system 1 in a specific storage area of the memory 22 in the CU 6 or the like. For example, the information indicating the operation mode may be a flag. The flag may be such that 0 is set in the normal mode and 1 is set in the load distribution mode.

The monitoring unit 61 compares the execution time of the job by the processing delay FPGA 9 with the execution time of the same job in a state where there is no occurrence of processing delay. When the difference in the execution time of the job is less than the predetermined time (threshold), the monitoring unit 61 detects resolution of the processing delay in the FPGA 9.

When the monitoring unit 61 detects the resolution of the processing delay in the FPGA 9, the monitoring unit 61 causes the operation mode of the present computer system 1 to transition from the load distribution mode to the normal mode.

When the monitoring unit 61 detects the processing delay in the FPGA 9, the monitoring unit 61 determines the FPGA 9 that is to assist the processing of the processing delay task in the processing delay FPGA 9, from among the multiple FPGAs 9 in the FPGA pool 8a. The FPGA 9 that is to assist the processing of the processing delay task in the processing delay FPGA 9 may be referred to as assistant FPGA 9. Causing the assistant FPGA 9 to also execute the processing of the processing delay task in the processing delay FPGA 9 (parallel processing) may achieve load distribution.

The processing delay FPGA 9 corresponds to the first device among the multiple devices. The assistant FPGA 9 corresponds to the second device among the multiple devices that is different from the first device.

The monitoring unit 61 may select the assistant FPGA 9 from among the FPGAs 9 in the hot standby state in the FPGA pool 8a, depending on the characteristic of the processing delay task. For example, the monitoring unit 61 may select the assistant FPGA 9 according to any of the following rules 1 to 3.

### (Rule 1)

For example, when the processing delay task includes many loop processes as the characteristic of the processing delay task, the monitoring unit 61 determines to append (add) a small-scale FPGA 9 having a circuit scale equal to or smaller than a first threshold, as the assistant FPGA 9. The processing delay FPGA 9 and the assistant FPGA 9 thereby process the processing delay task in parallel.

The case where the processing delay task includes many loop processes may include the case where the processing delay task includes a predetermined number or more of loops and the case where the number of times of loops in a loop process is large.

### (Rule 2)

For example, when the processing delay task includes a high-load process as the characteristic of the processing delay task, the monitoring unit 61 determines an FPGA 9 having higher processing performance than the processing delay FPGA 9, as the assistant FPGA 9. For example, the monitoring unit 61 determines to use a large-scale FPGA 9 having a circuit scale larger than a first threshold, as the assistant FPGA 9. The monitoring unit 61 offloads the processing of the processing delay task executed in the processing delay FPGA 9, to the assistant FPGA 9 with higher speed.

### (Rule 3)

For example, when the processing delay task includes many identical processes as the characteristic of the processing delay task, the monitoring unit 61 determines to add an assistant FPGA 9 having a circuit scale equivalent to that of the processing delay FPGA 9. The processing delay FPGA 9 and the assistant FPGA 9 thereby process the processing delay task in parallel.

When the monitoring unit 61 detects, for example, resolution of the processing delay in the processing delay FPGA 9, the operation mode of the present computer system 1 may transition from the load distribution mode to the normal mode. The monitoring unit 61 updates information indicating the operation mode of the present computer system 1.

The monitoring unit 61 may select the assistant FPGA 9 from among the FPGAs 9 in the hot standby state in the FPGA pool 8a. For example, the monitoring unit 61 may randomly determine the assistant FPGA 9 from among the multiple FPGAs 9 in the hot standby state. The monitoring unit 61 may preferentially select the FPGA 9 having the circuit scale equivalent to that of the processing delay FPGA 9 from among the FPGAs 9 in the hot standby state, as the assistant FPGA 9. The monitoring unit 61 may preferentially select the FPGA 9 having the larger circuit scale than the processing delay FPGA 9, as the assistant FPGA 9.

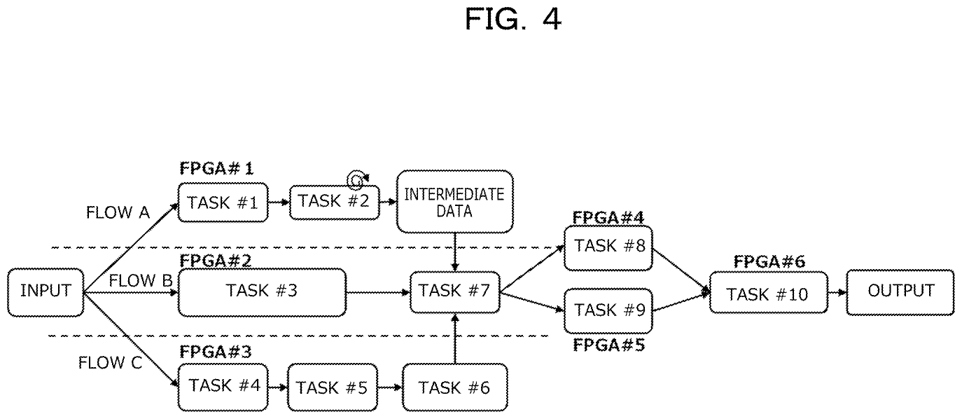

FIG. 4 is a diagram illustrating a method of enhancing parallel processing in the computer system 1 as an example of the first embodiment.

FIG. 4 illustrates an example in which a job including tasks #1 to #10 is processed. In FIG. 4, the tasks #1 to #7 are divided into three flows A, B, and C, and are processed in parallel by using three FPGAs #1 to #3. An FPGA #4 processes the task #8, an FPGA #5 processes the task #9, and an FPGA #6 processes the task #10, respectively.

For example, when the task #2 includes many loop processes, and the monitoring unit 61 detects the processing delay in the FPGA #1, the monitoring unit 61 may determine to append the assistant FPGA 9 that is to perform the processes of the task #2 and cause the assistant FPGA 9 to perform the parallel processing of the loops in the task #2, according to the rule 1.

For example, when the task #3 is a high load task and the monitoring unit 61 detects the processing delay in the FPGA #2, the monitoring unit 61 may determine to offload processes of the task #3 to the assistant FPGA 9 with higher speed and thereby reduce the processing time of the high-load task #3, according to the rule 2.

For example, when the task #10 includes many identical processes and the monitoring unit 61 detects the processing delay in the FPGA #6, the monitoring unit 61 may determine to append the assistant FPGA 9 having the circuit scale similar to that of the FPGA #6 and cause the assistant FPGA 9 to perform parallel processing of the processes in the task #10, according to the rule 3.

The first job transmission-reception unit 62a receives the jobs from the servers 3 via the CXL switch 4 (CXL extension function unit 5). The first job transmission-reception unit 62a implements a function as a slave that receives the jobs.

The first job transmission-reception unit 62a transmits the jobs to the FPGAs 9 via the FPGA extension function unit 7a. The first job transmission-reception unit 62a also implements a function as a master that transmits (sends) the jobs.

The first FPGA management unit 64a manages information (configuration information) on logic arrangement relating to each FPGA 9. For example, the configuration information may be stored in advance in the storage device 23 of the CU 6. Multiple types of configuration information may be prepared in advance for each FPGA 9 depending on the application, specification, or the like of the FPGA 9.

The first FPGA management unit 64a reads the configuration information corresponding to the assistant FPGA 9 from the storage device 23 depending on the assistant FPGA 9 determined by the monitoring unit 61, and forwards the configuration information to the first special packet processing unit 63.

When the monitoring unit 61 detects the processing delay in an FPGA 9, the first special packet processing unit 63 requests issuing of the special packet to the later-described CXL extension function unit 5. The first special packet processing unit 63 transmits information for specifying the assistant FPGA 9 and information for configuring the assistant FPGA 9 to the CXL extension function unit 5, together with the request for issuing of the special packet to the CXL extension function unit 5.

The special packet is a packet obtained by extending a packet confirming to the CXL protocol, and specific information for controlling the FPGA 9 is included in a specific area included in a known packet conforming to the CXL protocol. The special packet corresponds to a device control packet for controlling the FPGA 9 (device) in the FPGA pool 8a. Hereinafter, a packet conforming to the CXL protocol may be referred to as CXL packet.

The specific area in the CXL packet may be an unused area such as a spare area in the CXL packet.

The specific information for controlling the FPGA 9 may be information for setting the FPGA 9, and may include, for example, information (command) for initializing the FPGA 9 and information indicating types and arrangement of logical blocks set in the FPGA 9. The specific information for controlling the FPGA 9 may include the configuration information relating to the assistant FPGA 9 obtained from the first FPGA management unit 64a.

The first special packet processing unit 63 implements a function as a slave that receives the special packet transmitted from the CXL extension function unit 5 (second FPGA management unit 54a).

The first special packet processing unit 63 forwards the received special packet to the FPGA extension function unit 7a. This special packet includes the specific information for controlling the FPGA 9 that causes the FPGA extension function unit 7a to perform coupling, initialization, and logic arrangement of the assistant FPGA 9. For example, the first special packet processing unit 63 forwards the special packet to the FPGA extension function unit 7a to instruct the FPGA extension function unit 7a to set the assistant FPGA 9 to a usable state.

The CU 6 monitors the operation status (load status) of each FPGA 9 with the monitoring unit 61, and causes the assistant FPGA 9 to assist the processing of the processing delay task in the processing delay FPGA 9 in which the processing delay is detected to implement a function as a load balancer that distributes the load among the FPGAs 9. The CU 6 achieves such load distribution (balancing) among the FPGAs 9 without using the resources of the servers 3.

The CU 6 requests issuing of the special packet to the CXL extension function unit 5 by using the first special packet processing unit 63 to achieve the control of initialization, logic arrangement, and the like of the FPGAs 9. The CU 6 also achieves such control of the FPGAs 9 without using the resources of the servers 3.

The CXL extension function unit 5 generates and issues the special packet based on the request for issuing of the special packet from the CU 6 (first special packet processing unit 63).

As illustrated in FIG. 3, the CXL extension function unit 5 has functions as a packet reading unit 51, a second job transmission-reception unit 52a, a second special packet processing unit 53, and a second FPGA management unit 54a. The functions as the CXL extension function unit 5 may be implemented by, for example, a circuit device or by a processor executing a program, and may be carried out while being changed as appropriate.

The packet reading unit 51 reads packets of the CXL protocol transmitted from the servers 3.

The second job transmission-reception unit 52a receives the jobs from the servers 3 via the CXL switch 4. The second job transmission-reception unit 52a implements a function as a slave that receives the jobs.

The second job transmission-reception unit 52a transmits the jobs to the FPGAs 9 via the CU 6. The second job transmission-reception unit 52a also implements a function as a master that transmits (sends) the jobs.

The second FPGA management unit 54a prepares information for generating the special packet, in response to the request for issuing of the special packet from the CU 6.

For example, the information for generating the special packet may include information instructing coupling of the assistant FPGA 9, information instructing initialization of the assistant FPGA 9, and information indicating logic arrangement of the assistant FPGA 9.

The information indicating logic arrangement of the assistant FPGA 9 may be, for example, information transmitted from the CU 6 (first special packet processing unit 63) together with the request for issuing of the special packet. The second FPGA management unit 54a may generate the information indicating logic arrangement of the assistant FPGA 9 by itself or obtain it.

The second special packet processing unit 53 generates the special packet in response to the request for issuing of the special packet from the CU 6.

The second special packet processing unit 53 generates the special packet by storing the information instructing coupling of the assistant FPGA 9, the information instructing initialization of the assistant FPGA 9, and the information indicating logic arrangement of the assistant FPGA 9 that are prepared by the second FPGA management unit 54a, at predetermined locations of the CXL packet.

The second special packet processing unit 53 transmits the generated special packet to the CU 6. The second special packet processing unit 53 implements a function as a master that transmits the special packet.

The CXL extension function unit 5 corresponds to a device control packet generation unit that generates the special packet (device control packet) for controlling the assistant FPGA 9 (second device), based on the packet of the interconnect standard.

As illustrated in FIG. 3, the FPGA extension function unit 7a has, for example, functions as a third job transmission-reception unit 71a and a third FPGA management unit 72a. The function as the FPGA extension function unit 7a may be implemented by, for example, a circuit device or by a processor executing a program, and may be carried out while being changed as appropriate.

The FPGA extension function unit 7a corresponds to a device control unit, and sets the assistant FPGA 9 (second device) to an operable state based on the special packet (device control packet) generated by the CXL extension function unit 5 (device control packet generation unit).

The third job transmission-reception unit 71a transmits the jobs to the FPGAs 9, and receives execution results of the jobs from the FPGAs 9. The third job transmission-reception unit 71a functions as a master when transmitting the jobs to the FPGAs 9, and functions as a slave when receiving the execution results of the jobs from the FPGAs 9.

The third FPGA management unit 72a performs the coupling, the initialization, and the logic arrangement on the assistant FPGA 9, based on the information instructing the coupling of the assistant FPGA 9, the information instructing the initialization of the assistant FPGA 9, and the information indicating the logic arrangement of the assistant FPGA 9 that are included in the special packet.

For example, the third FPGA management unit 72a grasps the assistant FPGA 9 based on the information for specifying the assistant FPGA 9 that is included in the special packet. The third FPGA management unit 72a initializes this assistant FPGA 9, and sets the logic arrangement for this assistant FPGA 9 based on the information for configuring the assistant FPGA 9.

The coupling, the initialization, and the logic arrangement on the FPGA 9 may be achieved by known methods, and description thereof is omitted.

### (B) Operation

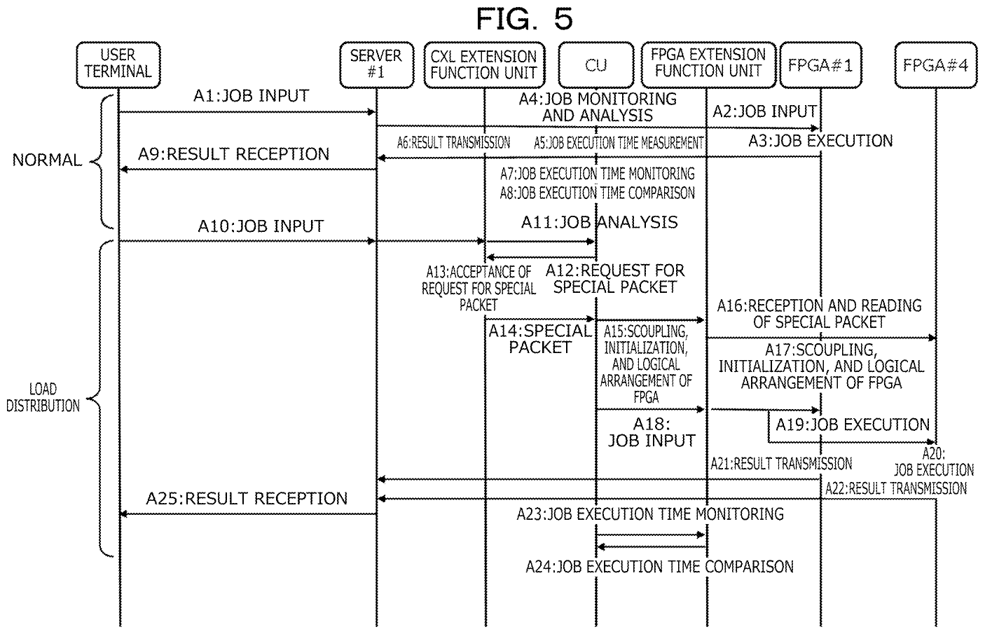

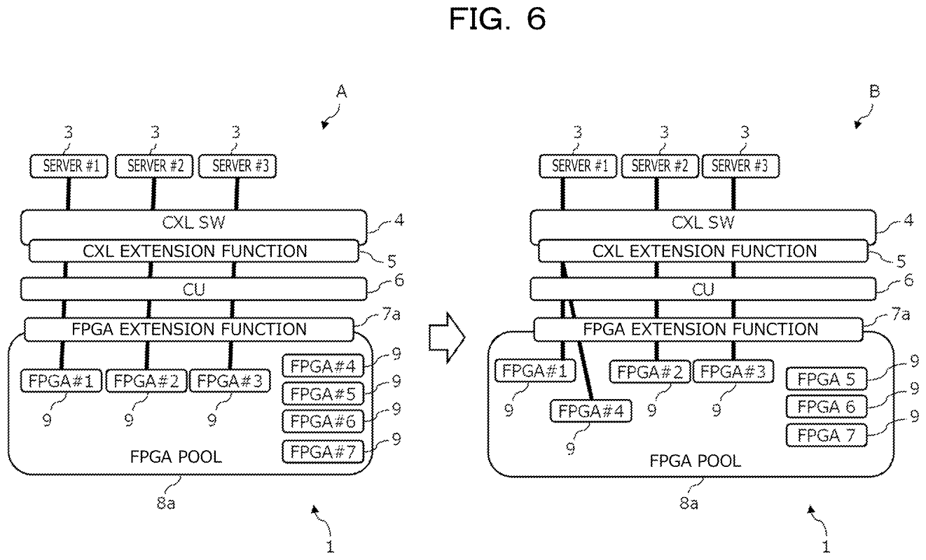

The processing in the computer system 1 as an example of the first embodiment configured as described above is explained according to the sequence diagram illustrated in FIG. 5 with reference to FIG. 6.

FIG. 6 is a diagram illustrating states of the computer system 1 before and after the processing illustrated in the sequence diagram of FIG. 5. In FIG. 6, reference sign A denotes a state before execution of the processing illustrated in FIG. 5, and reference sign B denotes a state after the execution of the processing.

Before the processing, as denoted by reference sign A in FIG. 6, the FPGAs #4 to #7 among the multiple FPGAs #1 to #7 are in the hot standby state. The FPGA #1 is coupled to the server #1, the FPGA #2 is coupled to the server #2, and the FPGA #3 is coupled to the server #3 on a one-to-one basis, respectively.

Description is given below of an example in which the user terminal 12 inputs a job into the server #1 among the multiple servers 3 and the FPGA #1 processes the inputted job. When the processing delay is detected in the FPGA #1, the monitoring unit 61 determines to append the FPGA #4 as the assistant FPGA 9 according to the rule 1 described above. The processing delay task is thereby processed in parallel by the processing delay FPGA #1 and the assistant FPGA #4.

In the computer system 1 in the normal mode, when the user terminal 12 inputs the job into the server #1 (see reference sign A1 in FIG. 5), this job is inputted into the FPGA #1 via the CXL switch 4, the CXL extension function unit 5, the CU 6, and the FPGA extension function unit 7a (see reference sign A2 in FIG. 5). The FPGA #1 executes the inputted job (see reference sign A3 in FIG. 5).

The monitoring unit 61 in the CU 6 monitors the execution of the job by the FPGA #1, and starts analysis (see reference sign A4 in FIG. 5). The monitoring unit 61 measures execution time of the job by the FPGA #1 (reference sign A5 in FIG. 5).

When the execution of the job is completed, the FPGA #1 transmits an execution result to the server #1 (see reference sign A6 in FIG. 5).

The monitoring unit 61 in the CU 6 monitors the execution time of the job (see reference sign A7 in FIG. 5), and compares the measured execution time with the previous execution time of the same job by the same FPGA #1 (see reference sign A8 in FIG. 5). Assume that, as a result of this comparison, the monitoring unit 61 detects that the execution time of the job is longer than the previous execution time of the same job by the predetermined time or more, and there is the processing delay in the FPGA #1. The computer system 1 thereby transitions from the normal mode to the load distribution mode.

The server #1 transmits the execution result of the job to the user terminal 12, and the user terminal 12 receives the transmitted execution result (see reference sign A9 in FIG. 5).

Then, when the user terminal 12 inputs a job into the server #1 again (see reference sign A10 in FIG. 5), this job is transmitted to the CU 6 via the CXL switch 4 and the CXL extension function unit 5. The monitoring unit 61 in the CU 6 analyzes the inputted job (see reference sign A11 in FIG. 5). For example, the monitoring unit 61 determines the assistant FPGA 9.

In the CU 6, the first special packet processing unit 63 transmits the information for specifying the assistant FPGA 9 and the information for configuring the assistant FPGA 9, together with the request for issuing of the special packet, to the CXL extension function unit 5 (see reference sign A12 in FIG. 5).

In the CXL extension function unit 5, the second special packet processing unit 53 receives the request for issuing of the special packet from the CU 6 (see reference sign A13 in FIG. 5), and generates the special packet. The second special packet processing unit 53 transmits the generated special packet to the CU 6 (see reference sign A14 in FIG. 5).

In the CU 6, the first special packet processing unit 63 forwards the special packet to the FPGA extension function unit 7a. The first special packet processing unit 63 forwards the special packet to the FPGA extension function unit 7a to instruct the FPGA extension function unit 7a to set the assistant FPGA 9 to the usable state. The instruction for setting the assistant FPGA 9 to the usable state includes instructions, respectively, for the coupling, initialization, and logic arrangement of the assistant FPGA 9 (see reference sign A15 in FIG. 5).

The FPGA extension function unit 7a receives and reads the special packet (see reference sign A16 in FIG. 5). The FPGA extension function unit 7a performs the coupling, the initialization, and the logic arrangement on the FPGA #4, according to the instruction for setting the assistant FPGA 9 to the usable state that is included in the special packet (see reference sign A17 in FIG. 5). As denoted by reference sign B in FIG. 6, the computer system 1 is thereby set to a state where use of the FPGA #1 and the FPGA #4 by the server #1 is made possible by the function of the CXL.

Then, the CU 6 inputs the job into the FPGA extension function unit 7a (see reference sign A18 in FIG. 5). The FPGA extension function unit 7a arranges the job into the FPGA #1 and the FPGA #4 in a distributed manner, and causes the FPGA #1 and the FPGA #4 to process the job in parallel (see reference signs A19 and A20 in FIG. 5).

The respective execution results of the job by the FPGA #1 and the FPGA #4 are each transmitted to the server #1 via the CU 6, the CXL extension function unit 5, and the CXL switch 4 (see reference signs A21 and A22 in FIG. 5).

The monitoring unit 61 in the CU 6 monitors the execution time of the job by each of the FPGAs #1 and #4 (see reference sign A23 in FIG. 5), and compares the measured execution time with the previous execution time of the same job by the each of the same FPGAs #1 and #4 (see reference sign A24 in FIG. 5). The server #1 transmits the execution results of the job to the user terminal 12 (see reference sign A25 in FIG. 5).

### [C] Effects

As described above, according to the computer system 1 as an example of the first embodiment, in the CU 6, the monitoring unit 61 monitors the job execution time by each FPGA 9, and when detecting the processing delay in an FPGA 9, transitions the operation mode to the load distribution mode and determines the assistant FPGA 9.

The first special packet processing unit 63 transmits the request for issuing of the special packet, together with the information for specifying the assistant FPGA 9 and the information for configuring the assistant FPGA 9, to the CXL extension function unit 5.

The CXL extension function unit 5 generates and issues the special packet, based on the request for issuing of the special packet from the CU 6 (first special packet processing unit 63).

In the FPGA extension function unit 7a, the third FPGA management unit 72a performs setting of the coupling, initialization, and logic arrangement of the assistant FPGA 9, based on the specific information for controlling the FPGA 9 that is included in the special packet.

As described above, when the processing delay occurs in the FPGA 9, it is possible to reduce the load of the processing delay FPGA 9 and improve the processing performance of the job (processing delay task) by setting the assistant FPGA 9 to the usable state and causing the assistant FPGA 9 to process the job. The use efficiency of the FPGAs 9 in the FPGA pool 8a may also be improved.

In this case, the CU 6, the CXL extension function unit 5, and the FPGA extension function unit 7a achieve the determination of the assistant FPGA 9 and the setting of the assistant FPGA 9, from the detection of the processing delay in the FPGA 9. Accordingly, no resources of the servers 3 are used and no communication with the servers 3 is performed. Thus, no load is placed on the servers 3 or the like.

In the CU 6, the first special packet processing unit 63 transmits the request for issuing of the special packet, together with the information for specifying the assistant FPGA 9 and the information for configuring the assistant FPGA 9, to the CXL extension function unit 5. The CXL extension function unit 5 generates the special packet, based on the request for issuing of the special packet from the CU 6 (first special packet processing unit 63), and transmits the special packet to the FPGA extension function unit 7a. The control of the FPGAs 9 may be thereby achieved among the CU 6, the CXL extension function unit 5, the FPGA pool 8a, and the FPGA extension function unit 7a, on the CXL protocol (interconnect standard).

For example, when there is a sudden processing request to one of the FPGAs 9 and scale-up of the system is desired, in the CU 6, the monitoring unit 61 detects the processing delay in the processing delay FPGA 9. The CU 6 may achieve addition of the assistant FPGA 9 and cause the assistant FPGA 9 to process the processing delay task (job) without intervention of the servers 3 by giving an instruction for a scale-up configuration among multiple configurations prepared in advance through the special packet.

### (II) DESCRIPTION OF SECOND EMBODIMENT

The computer system 1 of the first embodiment described above includes the FPGA pool 8a, and the CU 6 implements the function of controlling the FPGAs 9 in the FPGA pool 8a. However, the configuration is not limited to this.

The computer system 1 according to a second embodiment includes a GPU pool 8b, and the CU 6 controls GPUs 13 in the GPU pool 8b.

### (A) Configuration

### [A-1] Hardware Configuration Example

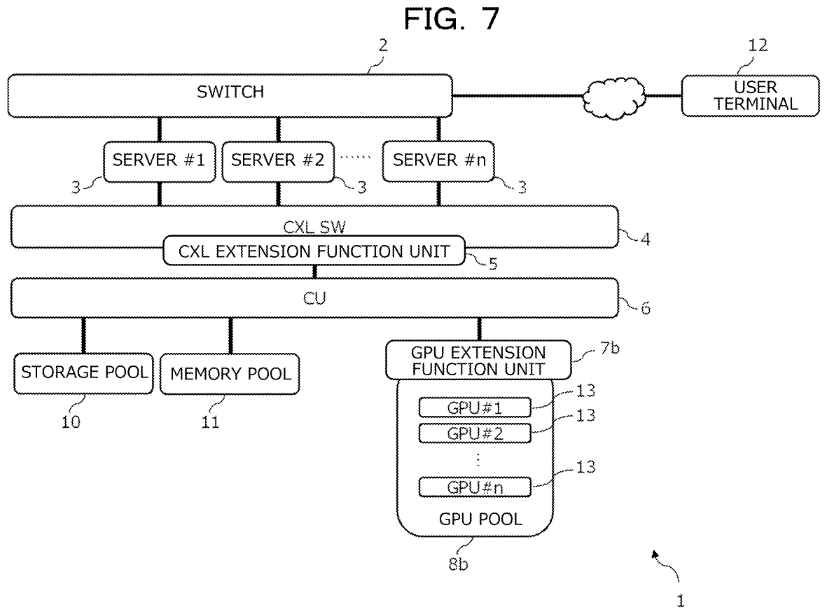

FIG. 7 is a diagram illustrating a configuration of the computer system 1 as an example of the second embodiment.

As illustrated in FIG. 7, the computer system 1 of the second embodiment includes the GPU pool 8b instead of the FPGA pool 8a in the first embodiment, and the other parts are configured in the same manner as those in the computer system 1 of the first embodiment.

Multiple GPUs (devices) 13 are registered in the GPU pool 8b. Programs inputted from the user terminal 12 are transmitted to the GPUs 13 in the GPU pool 8b via the servers 3, the CXL switch 4, and the CU 6. The GPUs 13 execute the received programs, and returns execution results (transmits results) of the programs to the servers 3 via the CU 6 and the CXL switch 4. The servers 3 transmit the returned execution results to the user terminal 12.

The multiple GPUs 13 registered in the GPU pool 8b may include a GPU 13 in the hot standby (hot spare) state in which no program is executed.

The GPU pool 8b includes a GPU extension function unit 7b. The GPU extension function unit 7b is interposed between the CU 6 and the GPU pool 8b. The GPU extension function unit 7b manages the GPUs 13 in the GPU pool 8b according to the special packet transmitted from the CU 6 (CXL switch 4).

### [A-2] Functional Configuration Example

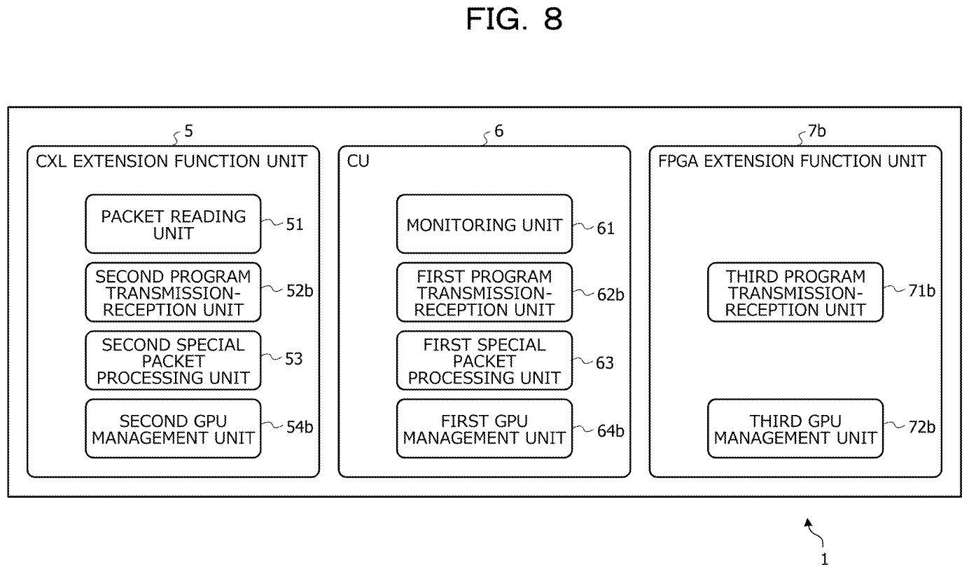

FIG. 8 is a diagram illustrating functional configurations of the CXL extension function unit 5, the CU 6, and the GPU extension function unit 7b in the computer system 1 as an example of the second embodiment.

The CU 6 is a control device that controls multiple devices (multiple

GPUs 13 in the present second embodiment), and implements a function of controlling the GPUs 13 in the GPU pool 8b without communicating with the processors of the servers 3.

When the control unit (CU) 6 detects a processing delay for a processing delay program (processing target) in a processing delay GPU 13 (first device) among the multiple GPUs 13 (devices), the CU 6 causes an assistant GPU 13 (second device) among the multiple GPUs 13 that is different from the processing delay GPU 13 to process the processing delay program that is the processing target.

The CU 6 achieves balancing of processing load as follows. The CU 6 monitors a load status of the GPU 13 and, when detecting the processing delay in the GPU 13, adds a GPU 13 to cause the added GPU 13 to assist the processing (programs).

As illustrated in FIG. 8, the CU 6 has functions as the monitoring unit 61, a first program transmission-reception unit 62b, the first special packet processing unit 63, and a first GPU management unit 64b.

The monitoring unit 61 monitors and analyzes an operation state of each of the GPUs 13 in the GPU pool 8b. The monitoring unit 61 may collect information indicating the operation status of each GPU 13 from the each GPU 13, as monitoring of the operation state of the each GPU 13.

For example, the monitoring unit 61 may obtain an execution state of the program in each GPU 13 as the information indicating the operation state of the each GPU 13. The execution state of the program may include, for example, the number (count) of programs to be processed by the GPU 13, power consumption, execution time, and the like. The execution time of the program in the GPU 13 may be time from start of execution of the program to output of the execution result by the GPU 13. The operation status of the GPU 13 may also be referred to as a load state of the GPU 13.

The information indicating the operation state of each GPU 13 is collected via the GPU extension function unit 7a to be described later.

The monitoring unit 61 measures a change in the information indicating the operation status, as analysis of the operation status of each GPU 13.

For example, the monitoring unit 61 compares the execution time of the program in the GPU 13 with the previous execution time of the same program by the same GPU 13. When the execution time of the program is longer than the previous execution time of the same program by predetermined time (threshold) or more as a result of the comparison, the processing delay in the GPU 13 is detected. The GPU 13 in which the processing delay is detected may be referred to as processing delay GPU 13. The program executed by the processing delay GPU 13 may be referred to as processing delay program.

When the monitoring unit 61 detects the processing delay in a GPU 13, the operation mode of the computer system 1 transitions from the normal mode to the load distribution mode. For example, the monitoring unit 61 may store information indicating the operation mode of the present computer system 1 in a specific storage area of the memory 22 in the CU 6 or the like. For example, the information indicating the operation mode may be a flag. The flag may be such that 0 is set in the normal mode and 1 is set in the load distribution mode.

The monitoring unit 61 compares the execution time of the program by the processing delay GPU 13 with the execution time of the same program in a state where there is no occurrence of processing delay. When the difference in the execution time of the program is less than the predetermined time (threshold), the monitoring unit 61 detects resolution of the processing delay in the GPU 13.

When the monitoring unit 61 detects the resolution of the processing delay in the GPU 13, the monitoring unit 61 causes the operation mode of the present computer system 1 to transition from the load distribution mode to the normal mode.

When the monitoring unit 61 detects the processing delay in the GPU 13, the monitoring unit 61 determines the GPU 13 that is to assist the execution of the processing delay program by the processing delay GPU 13, from among the multiple GPUs 13 in the GPU pool 8b. The GPU 13 that is to assist the execution of the processing delay program in the processing delay GPU 13 may be referred to as assistant GPU 13. Causing the assistant GPU 13 to also execute the processing of the processing delay program in the processing delay GPU 13 may achieve load distribution.

The processing delay GPU 13 corresponds to the first device among the multiple devices. The assistant GPU 13 corresponds to the second device among the multiple devices that is different from the first device.

The monitoring unit 61 may select the assistant GPU 13 from among the GPUs 13 in the hot standby state in the GPU pool 8b, depending on the characteristic of the processing delay program.

For example, when the monitoring unit 61 reads that processing performance improves in the case where multiple GPUs 13 executes the program in parallel in a log, the monitoring unit 61 may determine to increase the GPUs 13 (assistant GPUs 13) to execute the program. For example, when the monitoring unit 61 analyzes parallelism of the program of the GPU 13 based on the log and a performance improvement is expected by parallel execution of the program, the monitoring unit 61 may determine a GPU 13 equal to or superior than the processing delay GPU 13 as the assistant GPU 13. The monitoring unit 61 may determine to cause the processing delay GPU 13 and the selected assistant GPU 13 to execute the program in parallel.

When a GPU 13 with a higher performance than the processing delay GPU 13 is in the hot standby state and no performance improvement by the parallel execution of the program may be expected as a result of the analysis of the parallelism of the program of the GPU 13 based on the log, the monitoring unit 61 may determine the GPU 13 with higher performance as the assistant GPU 13, and cause the assistant GPU 13 to execute the program instead of the processing delay GPU 13.

When the monitoring unit 61 detects the resolution of the processing delay in the processing delay GPU 13, the operation mode of the present computer system 1 may transition from the load distribution mode to the normal mode. The monitoring unit 61 updates information indicating the operation mode of the present computer system 1.

The monitoring unit 61 may select the assistant GPU 13 from among the GPUs 13 in the hot standby state in the GPU pool 8b. For example, the monitoring unit 61 may randomly determine the assistant GPU 13 from among the multiple GPUs 13 in the hot standby state. The monitoring unit 61 may preferentially select a GPU 13 having a computation performance equivalent to that of the processing delay GPU 13 from among the GPUs 13 in the hot standby state, as the assistant GPU 13. The monitoring unit 61 may preferentially select a GPU 13 having a higher computation performance than the processing delay GPU 13, as the assistant GPU 13.

The first program transmission-reception unit 62b receives the programs to be executed by the GPUs 13 from the servers 3 via the CXL switch 4 (CXL extension function unit 5). The first program transmission-reception unit 62b implements a function as a slave that receives the programs.

The first program transmission-reception unit 62b transmits the programs to the GPUs 13 via the GPU extension function unit 7b, and causes the GPUs 13 to execute the programs. The first program transmission-reception unit 62b also implements a function as a master that transmits (sends) the programs.

The first GPU management unit 64b manages information for setting each GPU 13. For example, the information for setting the GPU 13 may include parameter information for initializing the GPU 13. For example, the information for setting the GPU 13 may be stored in advance in the storage device 23 of the CU 6. Multiple types of information may be prepared in advance for each GPU 13 depending on types of programs to be executed by the GPU 13, as the information for setting the GPU 13.

The first GPU management unit 64b reads the information for setting the GPU 13 that corresponds to the assistant GPU 13 from the storage device 23 depending on the assistant GPU 13 determined by the monitoring unit 61, and forwards the information to the first special packet processing unit 63.

When the monitoring unit 61 detects the processing delay in a GPU 13, the first special packet processing unit 63 requests issuing of the special packet to the later-described CXL extension function unit 5. The first special packet processing unit 63 transmits information for specifying the assistant GPU 13 and the information for setting the assistant GPU 13 to the CXL extension function unit 5, together with the request for issuing of the special packet to the CXL extension function unit 5.

The special packet is a packet obtained by extending a packet confirming to the CXL protocol, and specific information for controlling the GPU 13 is included in a specific area included in a known packet conforming to the CXL protocol.

The specific area in the CXL packet may be an unused area such as a spare area in the CXL packet.

The specific information for controlling the GPU 13 may be the information for setting the GPU 13, and may include, for example, information (command) for initializing the GPU 13. The specific information for controlling the GPU 13 may include the information for setting the assistant GPU 13 that is obtained from the first GPU management unit 64b.

The first special packet processing unit 63 implements a function as a slave that receives the special packet transmitted from the CXL extension function unit 5 (second GPU management unit 54a).

The first special packet processing unit 63 forwards the received special packet to the GPU extension function unit 7b. This special packet includes the specific information for controlling the GPU 13 that causes the GPU extension function unit 7b to perform coupling and initialization of the assistant GPU 13. For example, the first special packet processing unit 63 forwards the special packet to the GPU extension function unit 7b to instruct the GPU extension function unit 7b to set the assistant GPU 13 to a usable state.

The CU 6 monitors the operation status (load status) of each GPU 13 with the monitoring unit 61, and causes the assistant GPU 13 to assist the execution of the processing delay program in the processing delay GPU 13 in which the processing delay is detected to implement a function as a load balancer that distributes the load among the GPUs 13. The CU 6 achieves such load distribution (balancing) among the GPUs 13 without using the resources of the servers 3.

The CU 6 achieves the control of the coupling, initialization, and the like of the GPUs 13 by causing the first special packet processing unit 63 to request issuing of the special packet to the CXL extension function unit 5. The CU 6 also achieves such control of the GPUs 13 without using the resources of the servers 3.

The CXL extension function unit 5 generates and issues the special packet based on the request for issuing of the special packet from the CU 6 (first special packet processing unit 63).

As illustrated in FIG. 8, the CXL extension function unit 5 has functions as the packet reading unit 51, a second program transmission-reception unit 52b, the second special packet processing unit 53, and a second GPU management unit 54b. The functions as the CXL extension function unit 5 may be implemented by, for example, a circuit device or by a processor executing a program, and may be carried out while being changed as appropriate.

The second program transmission-reception unit 52b receives the programs from the servers 3 via the CXL switch 4. The second program transmission-reception unit 52b implements a function as a slave that receives the programs.

The second program transmission-reception unit 52b transmits the programs to the GPUs 13 via the CU 6. The second program transmission-reception unit 52b also implements a function as a master that transmits (sends) the programs.

The second GPU management unit 54b prepares information for generating the special packet, in response to the request for issuing of the special packet from the CU 6.

For example, the information for generating the special packet may include information instructing coupling of the assistant GPU 13 and information instructing initialization of the assistant GPU 13.

The second special packet processing unit 53 generates the special packet in response to the request for issuing of the special packet from the CU 6.

The second special packet processing unit 53 generates the special packet by storing the information instructing coupling of the assistant GPU 13 and the information instructing initialization of the assistant GPU 13 that are prepared by the second GPU management unit 54b, at predetermined locations of the CXL packet.

The second special packet processing unit 53 transmits the generated special packet to the CU 6. The second special packet processing unit 53 implements a function as a master that transmits the special packet.

The CXL extension function unit 5 corresponds to a device control packet generation unit that generates the special packet (device control packet) for controlling the assistant GPU 13 (second device), based on the packet of the interconnect standard.

As illustrated in FIG. 8, the GPU extension function unit 7b has, for example, functions as a third program transmission-reception unit 71b and a third GPU management unit 72b. The function as the GPU extension function unit 7b may be implemented by, for example, a circuit device or by a processor executing a program, and may be carried out while being changed as appropriate.

The GPU extension function unit 7b corresponds to a device control unit, and sets the assistant GPU 13 (second device) to an operable state based on the special packet (device control packet) generated by the CXL extension function unit 5 (device control packet generation unit).

The third program transmission-reception unit 71b transmits the programs to the GPUs 13, and receives execution results of the programs from the GPUs 13. The third program transmission-reception unit 71b functions as a master when transmitting the programs to the GPUs 13, and functions as a slave when receiving the execution results of the programs from the GPUs 13.

The third GPU management unit 72b performs the coupling and the initialization on the assistant GPU 13, based on the information instructing the coupling of the assistant GPU 13 and the information instructing the initialization of the assistant GPU 13 that are included in the special packet.

For example, the third GPU management unit 72b grasps the assistant GPU 13 based on the information specifying the assistant GPU 13 included in the special packet. The third GPU management unit 72b initializes the grasped assistant GPU 13.

The coupling and the initialization on the GPU 13 may be achieved by known methods, and description thereof is omitted.

The third GPU management unit 72b copies the program executed by the processing delay GPU 13 to a memory area or a storage area used by the assistant GPU 13 to cause the assistant GPU 13 to execute the program.

When a command to execute the program is issued from the server 3 to the GPU 13, for example, the third GPU management unit 72b causes the GPU 13 to execute the program by giving an instruction of an execution start position of the program. The instruction of the execution start position of the program may be, for example, an instruction of a CUDA program execution start position.

### (B) Operation

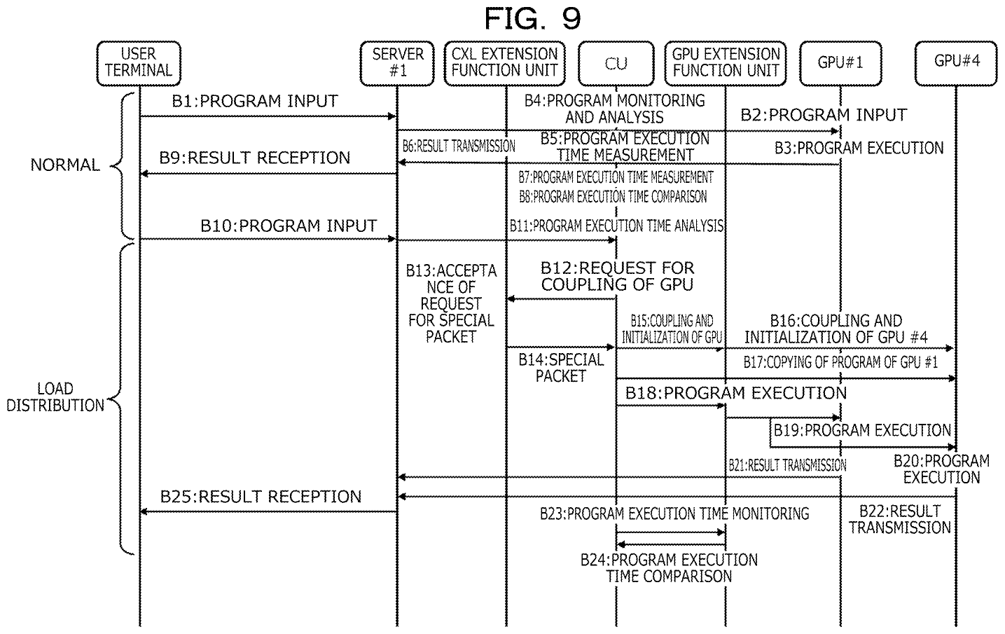

The processing in the computer system 1 as an example of the second embodiment configured as described above will be explained according to a sequence diagram illustrated in FIG. 9.

In the example described below, it is assumed that the GPU #1 is coupled to the server #1 on a one-to-one basis, and the GPU #4 among the multiple GPUs 13 in the GPU pool 8b is in the hot standby state, before the processing.

Description is given below of an example in which the user terminal 12 inputs a program into the server #1 among the multiple servers 3 and the GPU #1 executes the inputted program. When the processing delay is detected in the GPU #1, the monitoring unit 61 determines to append the GPU #4 as the assistant GPU 13. The processing delay program is thereby executed in parallel by the processing delay GPU #1 and the assistant GPU #4.

In the computer system 1 in the normal mode, when the user terminal 12 inputs the program into the server #1 (see reference sign B1 in FIG. 9), this program is inputted into the GPU #1 via the CXL switch 4, the CXL extension function unit 5, the CU 6, and the GPU extension function unit 7b (see reference sign B2 in FIG. 9). The GPU #1 executes the inputted program (see reference sign B3 in FIG. 9).

The monitoring unit 61 in the CU 6 monitors the execution of the program by the GPU #1, and starts analysis (see reference sign B4 in FIG. 9). The monitoring unit 61 measures execution time of the program by the GPU #1 (reference sign B5 in FIG. 9).

When the execution of the program is completed, the GPU #1 transmits an execution result to the server #1 (see reference sign B6 in FIG. 9).

The monitoring unit 61 in the CU 6 monitors the execution time of the program (see reference sign B7 in FIG. 9), and compares the measured execution time with the previous execution time of the same program by the same GPU #1 (see reference sign B8 in FIG. 9). Assume that, as a result of this comparison, the monitoring unit 61 detects that the execution time of the program is longer than the previous execution time of the same program by the predetermined time or more, and there is the processing delay in the GPU #1. The computer system 1 thereby transitions from the normal mode to the load distribution mode.

The server #1 transmits the execution result of the program to the user terminal 12, and the user terminal 12 receives the transmitted execution result (see reference sign B9 in FIG. 9).

Then, when the user terminal 12 inputs a program into the server #1 again (see reference sign B10 in FIG. 9), this program is transmitted to the CU 6 via the CXL switch 4 and the CXL extension function unit 5. The monitoring unit 61 in the CU 6 analyzes the inputted program (see reference sign B11 in FIG. 9). For example, the monitoring unit 61 determines the assistant GPU 13.

In the CU 6, the first special packet processing unit 63 transmits the information for specifying the assistant GPU 13 and the information for setting the assistant GPU 13, together with the request for issuing of the special packet, to the CXL extension function unit 5 (see reference sign B12 in FIG. 9). This request for issuing of the special packet functions as a coupling request of the assistant GPU 13.

In the CXL extension function unit 5, the second special packet processing unit 53 receives the request for issuing of the special packet from the CU 6 (see reference sign B13 in FIG. 9), and generates the special packet. The second special packet processing unit 53 transmits the generated special packet to the CU 6 (see reference sign B14 in FIG. 9).

In the CU 6, the first special packet processing unit 63 forwards the special packet to the GPU extension function unit 7b. The first special packet processing unit 63 forwards the special packet to the GPU extension function unit 7b to instruct the GPU extension function unit 7b to set the assistant GPU 13 to the usable state. The instruction for setting the assistant GPU 13 to the usable state includes instructions, respectively, for the coupling and initialization of the assistant GPU 13 (see reference sign B15 in FIG. 9).

The GPU extension function unit 7b receives and reads the special packet. The GPU extension function unit 7b performs the coupling and the initialization on the GPU #4, according to the instruction for setting the assistant GPU 13 to the usable state that is included in the special packet (see reference sign B16 in FIG. 9). The computer system 1 is thereby set to a state where use of the GPU #1 and the GPU #4 by the server #1 is made possible by the function of the CXL.

Then, the CU 6 gives an instruction to input and execute the program to the GPU extension function unit 7b (see reference sign B18 in FIG. 9). The GPU extension function unit 7b causes the GPU #1 and the GPU #4 to execute the program in parallel (see reference signs B19 and B20 in FIG. 9).

The respective execution results of the program by the GPU #1 and the GPU #4 are each transmitted to the server #1 via the CU 6, the CXL extension function unit 5, and the CXL switch 4 (see reference signs B21 and B22 in FIG. 9).

The monitoring unit 61 in the CU 6 monitors the execution time of the program by each of the GPUs #1 and #4 (see reference sign B23 in FIG. 9), and compares the measured execution time with the previous execution time of the same program by the each of the same GPUs #1 and #4 (see reference sign B24 in FIG. 9). The server #1 transmits the execution results of the program to the user terminal 12 (see reference sign B25 in FIG. 9).

### [C] Effects

As described above, according to the computer system 1 as an example of the second embodiment, operations and effects similar to those in the first embodiment may be obtained also for the GPUs 13.

For example, when the processing delay occurs in a GPU 13, it is possible to reduce the load of the processing delay GPU 13 and improve the processing performance of the program (processing delay program) by setting the assistant GPU 13 to the usable state and causing the assistant GPU 13 to execute the program. The use efficiency of the GPUs 13 in the GPU pool 8b may also be improved.

In this case, the CU 6, the CXL extension function unit 5, and the GPU extension function unit 7b achieve the determination of the assistant GPU 13 and the setting of the assistant GPU 13, from the detection of the processing delay in the GPU 13. Accordingly, no resources of the servers 3 are used and no communication with the servers 3 is performed. Thus, no load is placed on the servers 3 or the like.

In the CU 6, the first special packet processing unit 63 transmits the request for issuing of the special packet, together with the information for specifying the assistant GPU 13 and the information for setting the assistant GPU 13, to the CXL extension function unit 5. The CXL extension function unit 5 generates the special packet, based on the request for issuing of the special packet from the CU 6 (first special packet processing unit 63), and transmits the special packet to the GPU extension function unit 7b. The control of the GPUs 13 may be thereby achieved among the CU 6, the CXL extension function unit 5, the GPU extension function unit 7b, and the GPU pool 8b, on the CXL protocol (interconnect standard).

For example, when there is a sudden processing request to one of the GPUs 13 and scale-up of the system is desired, in the CU 6, the monitoring unit 61 detects the processing delay in the processing delay GPU 13. The CU 6 may achieve addition of the assistant GPU 13 and cause the assistant GPU 13 to process the processing delay program without the intervention of the servers 3 by instructing the CXL extension function unit 5 to issue the special packet.

### (III) OTHERS

The technique of the disclosure is not limited to each of the above-described embodiments, and may be carried out while being modified in various ways within a scope not departing from the spirit of the each embodiment.

For example, description is given above of the example in which the CU 6 controls the FPGAs 9 of the FPGA pool 8a in the computer system 1 according to the first embodiment and the example in which the CU 6 controls the GPUs 13 of the GPU pool 8b in the computer system 1 according to the second embodiment. However, the present disclosure is not limited to this.

For example, the CU 6 may control the multiple storage devices in the storage pool 10 or the multiple memory devices in the memory pool 11, and may be carried out while being changed as appropriate.

Although the example in which the CU 6 is provided independently of the CXL switch 4 is described in each of the above-described embodiments, the present disclosure is not limited to this configuration. For example, the CXL switch 4 and the CU 6 may be configured to be integral. The CU 6 may include the function as the FPGA extension function unit 7a or the GPU extension function unit 7b.

Each of the configurations and processes in the present embodiments may be selectively employed or omitted as desired or may be combined as appropriate.

For example, the first embodiment and the second embodiment may be combined. For example, the configuration may be such that the computer system 1 includes the FPGA pool 8a and the GPU pool 8b, and the CU 6 controls the FPGAs 9 in the FPGA pool 8a and the GPUs 13 in the GPU pool 8b.

The above-described disclosure allows a person skilled in the art to carry out and manufacture the present embodiments.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing apparatus provided in a computer system including
a first processor; an interconnect switch that conforms to an interconnect standard
and a plurality of devices coupled to the processor via the interconnect switch, comprising:
a second processor, when a processing delay for a processing target is detected in a first device among the plurality of devices, configured to cause a second device among the plurality of devices that is different from the first device to process the processing target.

2. The information processing apparatus according to claim 1, wherein
the computer system includes
a device control packet generator configured to generate a device control packet for controlling the second device, based on a packet of the interconnect standard, and
a device controller configured to control the plurality of devices,
the second processor requests issuing of the device control packet to the device control packet generator, and
the device controller sets the second device to an operable state, based on the device control packet generated by the device control packet generator.

3. The information processing apparatus according to claim 2, wherein
the devices are each a field-programmable gate array (FPGA), and the device controller sets logic arrangement of the FPGA according to the device control packet.

4. The information processing apparatus according to claim 2, wherein
the devices are each a graphics processing unit (GPU), and the device controller initializes the GPU according to the device control packet.

5. A non-transitory computer-readable recording medium storing a program causing a second processor included in an information processing apparatus in a computer system including a first processor, an interconnect switch that conforms to an interconnect standard and a plurality of devices coupled to the first processor via the interconnect switch to execute a processing of:
when a processing delay for a processing target is detected in a first device among the plurality of devices, causing a second device among the plurality of devices that is different from the first device to process the processing target.

6. The non-transitory computer-readable recording medium according to claim 5, wherein
the computer system includes
a device control packet generator configured to generate a device control packet for controlling the second device, based on a packet of the interconnect standard, and
a device controller configured to control the plurality of devices,
the second processor requests issuing of the device control packet to the device control packet generator, and
the device controller sets the second device to an operable state, based on the device control packet generated by the device control packet generator.

7. The non-transitory computer-readable recording medium according to claim 6, wherein
the devices are each a field-programmable gate array (FPGA), and the device controller sets logic arrangement of the FPGA according to the device control packet.

8. The non-transitory computer-readable recording medium according to claim 6, wherein
the devices are each a graphics processing unit (GPU), and the device controller initializes the GPU according to the device control packet.

9. A control method comprising:
causing a second processor included in an information processing apparatus in a computer system including a first processor, an interconnect switch that conforms to an interconnect standard and a plurality of devices coupled to the first processor via the interconnect switch to execute a processing of:
when a processing delay for a processing target is detected in a first device among the plurality of devices, causing a second device among the plurality of devices that is different from the first device to process the processing target.

10. The control method according to claim 9, wherein
the computer system includes
a device control packet generator configured to generate a device control packet for controlling the second device, based on a packet of the interconnect standard, and
a device controller configured to control the plurality of devices,
the second processor requests issuing of the device control packet to the device control packet generator, and
the device controller sets the second device to an operable state, based on the device control packet generated by the device control packet generator.

11. The control method according to claim 10, wherein
the devices are each a field-programmable gate array (FPGA), and the device controller sets logic arrangement of the FPGA according to the device control packet.

12. The control method according to claim 10, wherein
the devices are each a graphics processing unit (GPU), and the device controller initializes the GPU according to the device control packet.
